(19) United States
(12) Patent Application Publication
(10) Pub. No.: US 2022/0393902 A1
(43) Pub. Date: Dec. 8, 2022

(54) CONTROL SYSTEM AND CONTROL METHOD

(71) Applicant: Panasonic Intellectual Property Management Co., Ltd., Osaka (JP)

(72) Inventors: Kousei MATSUNAMI, Kyoto (JP); Kiyonori KIDO, Tokyo (JP); Makoto HIROKI, Tokyo (JP)

(21) Appl. No.: 17/771,746

(22) PCT Filed: Nov. 2, 2020
(86) PCT No.: PCT/JP2020/041127

§ 371 Date: Apr. 25, 2022

(30) Foreign Application Priority Data
Nov. 5, 2019 (JP) 2019-200552

(51) Int. Cl. H04L 12/28; G06F 3/16; G06F 3/04842

(52) U.S. Cl. CPC H04L 12/282; G06F 3/16; G06F 3/04842

(57) ABSTRACT

A control system includes: an input receiver that receives an input of a user; a second communicator that communicates with devices; and a controller that causes the input receiver to be in a preparation state in response to the communicator obtaining predetermined information from one device among the devices. The preparation state is a state in which the input receiver is able to receive an execution input for executing scene control related to a life scene for at least part of the devices.

### CROSS-REFERENCE OF RELATED APPLICATIONS

This application is the U.S. National Phase under 35 U.S.C. § 371 of International Patent Application No. PCT/JP2020/041127, filed on Nov. 2, 2020, which in turn claims the benefit of Japanese Patent Application No. 2019-200552, filed on Nov. 5, 2019, the entire disclosures of which Applications are incorporated by reference herein.

The present invention relates to a control system and a control method.

### BACKGROUND ART

In recent years, a home energy management system (HEMS) has been introduced to houses. HEMS implements “visualization” in which the amount of usage of energy such as electricity and gas for house use is displayed on a monitor. Moreover, HEMS can be also used as a control system for controlling household electrical appliances installed in a house.

As a technique for controlling electric household appliances, PTL 1 discloses, for example, a device controller having modes such as a going-out mode, a returning-home mode, and a getting-up mode, by which electric household appliances can be collectively controlled.

### CITATION LIST

### Patent Literature

[PTL 1] Japanese Unexamined Patent Application Publication No.

### SUMMARY OF INVENTION

### Technical Problem

In order to collectively control electric household appliances (hereinafter also described as scene control), multiple inputs are typically necessary for a user interface. In other words, steps are complicated before scene control is executed.

The present invention provides a control system and a control method that can simplify steps before scene control is executed.

### Solution to Problem

In accordance with an aspect of the present invention, a control system includes: an input receiver that receives an input of a user; a communicator that communicates with devices; and a controller that causes the input receiver to be in a preparation state in response to the communicator obtaining predetermined information from one device among the devices, the preparation state being a state in which the input receiver is able to receive an execution input for executing scene control of at least part of the devices, the scene control being related to a life scene.

In accordance with another aspect of the present invention, a control method includes: communicating with devices; and causing an input receiver for receiving an input of a user to be in a preparation state in response to obtaining of predetermined information from one device among the devices in the communicating, the preparation state being a state in which the input receiver is able to receive an execution input for executing scene control of at least part of the devices, the scene control being related to a life scene.

In accordance with still another aspect of the present invention, a non-transitory computer-readable recording medium having recorded thereon a program causes a computer to execute the control method described above.

### Advantageous Effect of Invention

The control system and the control method according to the present invention can simplify steps before scene control is executed.

### BRIEF DESCRIPTION OF DRAWINGS

FIG. 1 is a block diagram illustrating a functional configuration of a control system according to an embodiment.

FIG. 2 is a diagram illustrating an example of control information for executing scene control.

FIG. 3 is a flowchart showing operation example 1 of the control system according to the embodiment.

FIG. 4 is a diagram illustrating an example of a screen for executing the scene control of “returning-home”.

FIG. 5 is a diagram illustrating an example of an execution screen superimposed on the other screen.

FIG. 6 is a flowchart showing operation example 2 of the control system according to the embodiment.

FIG. 7 is a diagram illustrating an example of a voice input screen.

### DESCRIPTION OF EMBODIMENT

Hereinafter, a certain exemplary embodiment will be described in detail with reference to the accompanying Drawings. The following embodiment is a general or specific example of the present invention.

The numerical values, shapes, materials, elements, arrangement and connection configuration of the elements, steps, the order of the steps, etc., described in the following embodiment are merely examples, and are not intended to limit the present invention. Among elements in the following embodiment, those not described in any one of the independent claims indicating the broadest concept of the present invention are described as optional elements.

It should be noted that the respective figures are schematic diagrams and are not necessarily precise illustrations. Additionally, components that are essentially the same share like reference signs in the figures. Accordingly, overlapping explanations thereof are omitted or simplified.

### (Embodiment)

### [Configuration]

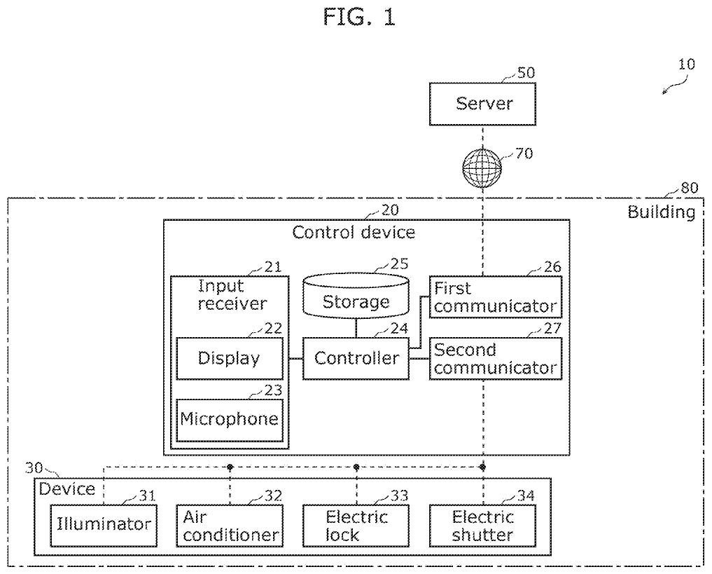

The configuration of a control system according to an embodiment will be first described below. FIG. 1 is a block diagram illustrating a functional configuration of the control system according to the embodiment.

As illustrated in FIG. 1, control system 10 includes control device 20, device 30, and server 50.

Building 80 illustrated in FIG. 1 is a house, for example, an apartment house or a detached house. Control device 20 and device 30 are installed in building 80. Server 50 is implemented as a cloud (i.e., a cloud server).

Control device 20 will be first described below. Control device 20 is, for example, a HEMS controller having an energy management function. Control device 20 is installed in building 80 to manage the power consumption of device 30 installed in building 80. Moreover, control device 20 acquires and displays a state of device 30 and controls device 30 installed in building 80 (or in the site of building 80). Control device 20 is not limited to a HEMS controller. Other home controllers having no energy management function or a gateway device may be used instead.

Device 30 is a household electrical appliance such as illuminator 31 and air conditioner 32. A state of device 30 means, for example, an operation state of device 30 and a state of power consumption of device 30. Specifically, an operation state includes a power-on state, a power-off state, and a setting state (a set temperature when an air conditioner serves as device 30 or brightness when an illuminator serves as device 30).

Specifically, control device 20 includes display 22, microphone 23, controller 24, storage 25, first communicator 26, and second communicator 27. Display 22 and microphone 23 constitute input receiver 21.

Display 22 is a display device having the function of displaying an image and the function of receiving a manual input of a user. Display 22 is implemented by a touch panel and a display panel such as a liquid crystal panel or an organic electro luminescence (EL) panel. The touch panel is, for example, a capacitive touch panel and may be a resistive touch panel.

Microphone 23 receives the voice input of the user. Microphone 23 is an example of a voice acquirer.

Controller 24 executes, for example, display control of an image on display 22 and voice recognition of a voice input to microphone 23. Controller 24 is implemented by, for example, a microcomputer. Controller 24 may be implemented by a processor.

Storage 25 is a storage device for storing, for example, control programs executed by controller 24. Storage 25 is implemented by, for example, semiconductor memory or the like.

First communicator 26 is a communication module (communication circuit) for communications between control device 20 and server 50 via wide area network 70, e.g., the Internet. Communications conducted by first communicator 26 is, for example, radio communications. Cable communications may be conducted instead. Communications standards used for such communications are not particularly limited.

Second communicator 27 is a communication module (communication circuit) for communications between control device 20 and device 30 via a local communication network.

Communications conducted by second communicator 27 is, for example, radio communications. Cable communications may be conducted instead. Communications standards used for such communications are not particularly limited. Communications between second communicator 27 and device 30 are compliant with, for example, ECHONET Lite (registered trademark).

Device 30 will be described below. Device 30 is a device to be controlled by control device 20. Device 30 includes, for example, a communication module (communication circuit) for communications with control device 20 and operates according to a control signal received from control device 20. Device 30 includes, for example, illuminator 31, air conditioner 32, electric lock 33, and electric shutter 34

Device 30 may include other devices. For example, device 30 may include devices such as a distribution switch board or a smart meter that measures power consumption in building 80. Power consumption measured by such devices is stored in storage 25 as history information about power consumption.

Illuminator 31 illuminates the inside (interior) of building 80. Illuminator 31 is, for example, a ceiling light. A specific form of illuminator 31 is not particularly limited. Illuminator 31 may be, for example, a downlight, a pendant light, a spot light, or a bracket light. Alternatively, illuminator 31 may be an illuminator for illuminating the outside (exterior) of building 80.

Air conditioner 32 is an air conditioner for ordinary households.

Air conditioner 32 is an air conditioner including a heat exchanger (not illustrated), thereby adjusting the temperature of wind blowing from air conditioner 32. In other words, air conditioner 32 has a temperature adjusting function (air-blowing function and air conditioning function). Air conditioner 32 is not limited to an air-conditioner for ordinary households. An industrial air conditioner may be used instead.

Electric lock 33 is a security device for controlling the locking and unlocking of a door (or a window) provided for building 80.

Electric lock 33 includes, for example, an RFID reader for acquiring key information from a card key or the like. Alternatively, electric lock 33 may be provided with a biological sensor for acquiring, as key information, biological information including fingerprints. In the following embodiment, electric lock 33 will be described as an electric lock provided on an entrance door.

Electric shutter 34 is disposed outside (or inside) a window of building 80 and adjusts the amount of natural light brought into building 80. Electric shutter 34 is, for example, an electric blind that is configured to physically open and close a shield against light. Electric shutter 34 may include a liquid crystal panel and may be configured to change light transmittance as physical properties.

### [Scene Control]

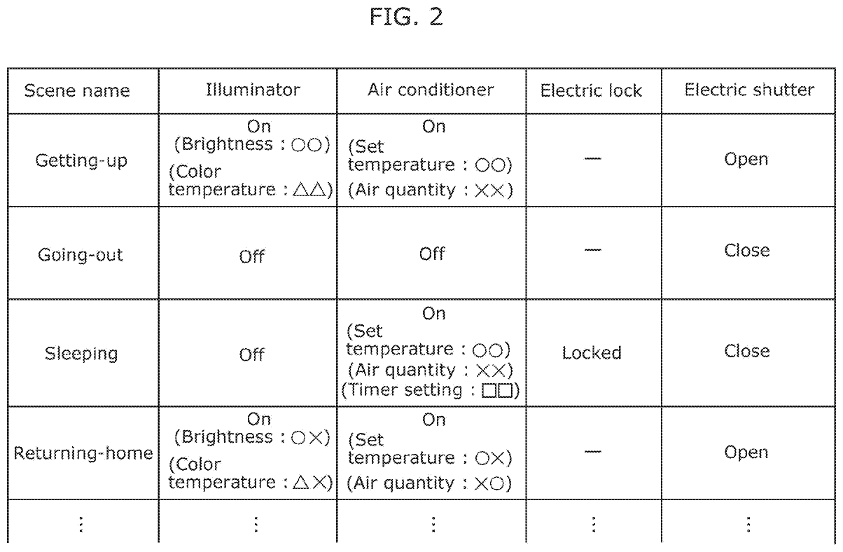

Scene control executed by control device 20 will be described below. In scene control, two or more devices 30 disposed in building 80 are collectively operated to bring the inside of building 80 to a predetermined indoor environment. FIG. 2 is a diagram illustrating an example of control information for executing scene control.

In the control information on scene control, the control contents of device 30 are associated with respective life scenes (scene names) including getting-up, going-out, and sleeping. For example, when a user operates display 22 to provide an execution instruction (hereinafter, referred also to as execution input) to execute scene control of “getting-up,” control device 20 controls device 30 with reference to the control information of FIG. 2. Thus, illuminator 31 and air conditioner 32 are turned on with preregistered settings (including brightness and a set temperature), thereby opening electric shutter 34. The user can preregister an operation to be executed by device 30 and which one of devices 30 is to execute the operation when the execution instruction to execute scene control of “getting-up” is provided.

### [Operation Example 1]

In response to a state change of one device 30 among devices 30, control system 10 can display an execution screen of scene control related to a life scene suggested from the state change of device 30.

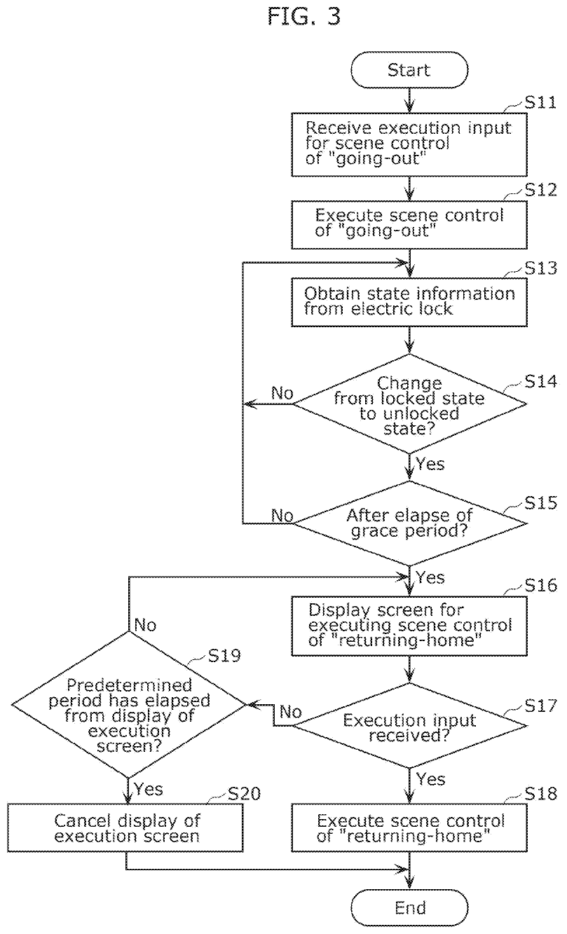

For example, in response to an unlocked state of electric lock 33, control system 10 suggests that the unlocked state indicates the return of the user and displays a screen for executing the scene control of “returning-home”. Operation example 1 of control system 10 configured thus will be described below. FIG. 3 is a sequence diagram showing operation example 1 of control system 10.

When display 22 receives an execution input for the scene control of “going-out” of the user (S11), controller 24 of control device 20 executes the scene control of “going-out” (S12). Specifically, controller 24 refers to control information (FIG. 2) on scene control and causes second communicator 27 to transmit a control signal to device 30 to be controlled in the scene control of “going-out,” the control information being stored in storage 25 in advance. In the example of FIG. 2, devices 30 to be controlled are illuminator 31, air conditioner 32, and electric shutter 34. When the scene control of “going-out” is executed, illuminator 31 and air conditioner 32 are turned off, and electric shutter 34 is closed.

Thereafter, when second communicator 27 obtains, from electric lock 33, state information indicating a state of electric lock (S13), controller 24 determines whether the obtained state information indicates that electric lock 33 has changed from a locked state to an unlocked state (S14). The state information is an example of predetermined information. The predetermined information may be information other than state information if the information is usable as a trigger.

If it is determined that the obtained state information does not indicate that electric lock 33 has changed from a locked state to an unlocked state (No at S14), state information is obtained again (S13). If it is determined that the state information indicates that electric lock 33 has changed from a locked state to an unlocked state (Yes at S14), controller 24 determines whether the current time (a time when the state information is obtained) is a time after the elapse of a grace period (S15). The grace period is a period in which the user performs an execution input for scene control of “going-out” at the start time. The grace period is, for example, a period of about thirty minutes but is not particularly limited thereto. The duration of the grace period may be set based on a user input to display 22.

If the current time is determined as a time within the grace period (No at S15), electric lock 33 may be unlocked to allow the user to go out of building 80. In other words, in this case, the display of the screen for executing the scene control of “returning-home” is not appropriate. Thus, in this case, the screen for executing the scene control of “returning-home” is not displayed, and state information is obtained again (S13).

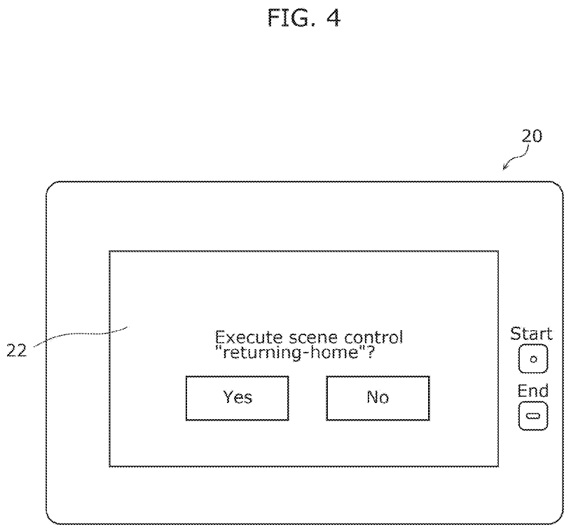

If the current time is determined as a time after the elapse of the grace period (Yes at S15), it is assumed that electric lock 33 is unlocked when the user actually returns home. Thus, if the current time is determined as a time after the elapse of the grace period (Yes at S15), controller 24 causes display 22 to display the screen for executing the scene control of “returning-home” (S16). FIG. 4 is a diagram illustrating an example of a screen for executing the scene control of “returning-home”.

As illustrated in FIG. 4, the screen for executing the scene control of “returning-home” (hereinafter also simply referred to as an execution screen) includes an object (e.g., a “Yes” button in FIG. 4) for executing the scene control of “returning-home”. In other words, a state in which the execution screen is displayed is a preparation state in which an execution input for executing scene control can be received.

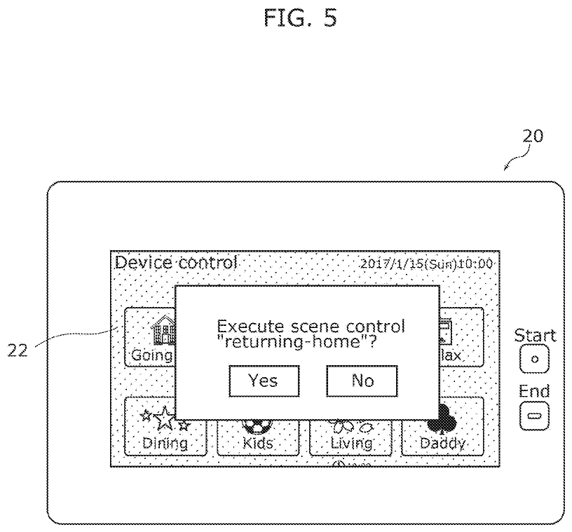

When display 22 in a sleep state displays a standby screen (e.g., a black screen), controller 24 activates display 22 and causes activated display 22 to display the execution screen. In other words, display 22 switches the standby screen to the execution screen. When display 22 displays a screen other than the standby screen, controller 24 causes display 22 to replace the screen with the execution screen (that is, the screen is changed). The execution screen may be superimposed on the other screen (in other words, a pop-up window). FIG. 5 is a diagram illustrating an example of the execution screen superimposed on the other screen. The other screen is, for example, a control screen for controlling device 30.

While the execution screen is displayed, controller 24 determines whether display 22 has received an execution input for the scene control of “returning-home” (e.g., a tap on the button “Yes” in FIGS. 4 and 5) (S17). When it is determined that display 22 has received an execution input for the scene control of “returning-home” (Yes at S17), controller 24 executes the scene control of “returning-home” (S18). Specifically, controller 24 refers to control information (FIG. 2) on scene control and causes second communicator 27 to transmit a control signal to device 30 to be controlled in the scene control of “returning-home,” the control information being stored in advance in storage 25. In the example of FIG. 2, devices 30 to be controlled are illuminator 31, air conditioner 32, and electric shutter 34. When the scene control of “returning-home” is executed, illuminator 31 and air conditioner 32 are turned on, and electric shutter 34 is opened.

When it is determined that display 22 has not received an execution input for the scene control of “returning-home” (No at S17), controller 24 determines whether a predetermined period has elapsed from the start of the display of the execution screen (S19). The predetermined period is, for example, a period of about thirty minutes but is not particularly limited thereto. The duration of the predetermined period may be set based on a user input to display 22.

When it is determined that the predetermined period has not elapsed from the start of the display of the execution screen (No at S19), controller 24 causes display 22 to continuously display the execution screen (S16). When it is determined that the predetermined period has elapsed (Yes at S19), controller 24 determines that the user does not intend to execute the scene control of “returning-home” and causes display 22 to cancel the display of the execution screen (S20). In this case, display 22 displays, for example, the preceding screen (the standby screen or another screen) of the execution screen.

As described above, in response to second communicator 27 obtaining predetermined information (specifically, state information indicating a change of electric lock 33 to an unlocked state) from electric lock 33, control system 10 causes input receiver 21 to be in a preparation state in which input receiver 21 is able to receive an execution input for executing scene control. Specifically, control system 10 causes input receiver 21 to be in the preparation state by causing display 22 to display the execution screen including an object for executing the scene control. The execution screen is a screen that allows the user to execute scene control with one touch. After electric lock 33 is unlocked, the execution screen is displayed before a user input (operation) on display 22. Thus, the user can quickly execute the scene control.

### [Operation Example 2]

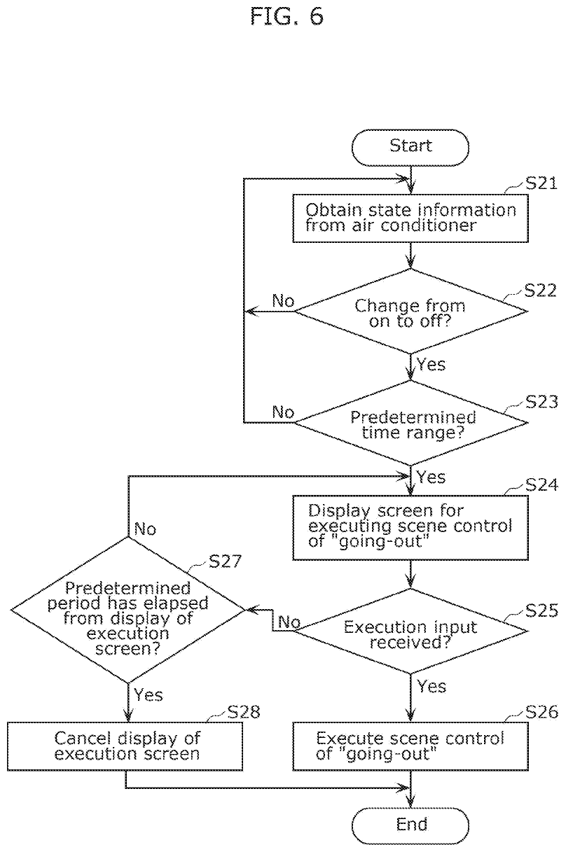

In operation example 1, on conditions that the scene control of “going-out”, which is different from the scene control of “returning-home,” is executed and then the predetermined information is obtained from electric lock 33, control system 10 causes display 22 to display the execution screen for executing the scene control of “returning-home.” However, such a configuration is not always necessary. For example, on condition that the predetermined information is obtained from device 30 in a predetermined time range, control system 10 may cause display 22 to display the execution screen. Operation example 2 of control system 10 configured thus will be described below. FIG. 6 is a flowchart showing operation example 2 of control system 10.

When second communicator 27 obtains state information, which indicates a state of air conditioner 32, from air conditioner 32 (S21), controller 24 of control device 20 determines whether the obtained state information indicates a change of air conditioner 32 from an on-state to an off-state (S22).

If it is determined that the obtained state information does not indicate a change of air conditioner 32 from an on-state to an off-state (No at S22), state information is obtained again (S21). If it is determined that the state information indicates a change of air conditioner 32 from an on-state to an off-state (Yes at S22), controller 24 determines whether the current time (a time when the state information is obtained) belongs to the predetermined time range (S23). In operation example 2, the predetermined time range is a time range in which the user is likely to go out, for example, a time range from 8:00 to 20:00. The predetermined time range may be set based on a user input to display 22.

If it is determined that the current time does not belong to the predetermined time range (No at S23), it is assumed that the turning off of air conditioner 32 is not for the user to go out of building 80. Thus, in this case, the screen for executing the scene control of “going-out” is not displayed, and state information is obtained again (S21).

If it is determined that the current time belongs to the predetermined time range (Yes at S23), it is assumed that the turning off of air conditioner 32 is for the user to go out of building 80. Thus, if it is determined that the current time belongs to the predetermined time range (Yes at S23), controller 24 causes display 22 to display the screen for executing the scene control of “going-out” (S24). The processing of step S24 is similar to that of step S16 in operation example 1 except for the different contents of scene control.

While the execution screen is displayed, controller 24 determines whether display 22 has received an execution input for the scene control of “going-out” (S25). When it is determined that display 22 has received an execution input for the scene control of “going-out” (Yes at S25), controller 24 executes the scene control of “going-out” (S26). The processing of step S26 is similar to that of step S18 in operation example 1 except for the different contents of scene control.

When it is determined that display 22 has not received an execution input for the scene control of “going-out” (No at S25), controller 24 determines whether a predetermined period has elapsed from the start of the display of the execution screen (S27). The predetermined period is, for example, a period of about thirty minutes but is not particularly limited thereto. The duration of the predetermined period may be set based on a user input to display 22.

When it is determined that the predetermined period has not elapsed from the start of the display of the execution screen (No at S27), controller 24 causes display 22 to continuously display the execution screen (S24). When it is determined that the predetermined period has elapsed (Yes at S27), controller 24 determines that the user does not intend to execute the scene control of “going-out” and causes display 22 to cancel the display of the execution screen (S28). In this case, display 22 displays, for example, the preceding screen (the standby screen or another screen) of the execution screen.

As described above, in operation example 2, in response to second communicator 27 obtaining predetermined information (specifically, state information indicating a change of air conditioner 32 to an off-state) from air conditioner 32 in the predetermined time range, control system 10 causes input receiver 21 to be in a preparation state in which input receiver 21 is able to receive an execution input for executing scene control. Thus, the user can quickly execute the scene control.

### [Modification 1]

In operation example 1 and operation example 2, scene control is executed by a manual input to an object included in the execution screen. Scene control may be executed by a voice input.

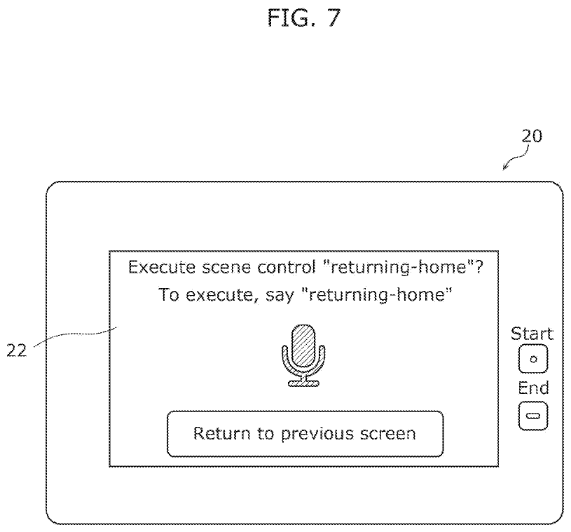

In this case, in step S14 of operation example 1 (or step S24 of operation example 2), controller 24 activates microphone 23 and causes display 22 to display a voice input screen. In other words, in response to second communicator 27 obtaining predetermined information (specifically, state information indicating a change of electric lock 33 to an unlocked state) from electric lock 33, controller 24 activates microphone 23 and causes display 22 to display the voice input screen. FIG. 7 is a diagram illustrating an example of the voice input screen.

The activation of microphone 23 is to turn on microphone 23 to allow microphone 23 to obtain a voice. At this point, controller 24 is placed in a standby state that enables voice recognition of a voice input through microphone 23. In other words, the state that enables voice recognition by controller 24 is a preparation state in which an execution input for executing scene control can be received.

As described above, in response to second communicator 27 obtaining predetermined information (specifically, state information indicating a change of electric lock 33 to an unlocked state) from electric lock 33, control system 10 may activate microphone 23 to cause input receiver 21 to be in the preparation state.

### [Modification 2]

The processing executed by control device 20 in the foregoing embodiment may be partially or entirely executed by server 50. For example, control device 20 may mainly act as a user interface while substantial information processing for scene control may be conducted by server 50.

### [Effects]

As described above, control system 10 includes: input receiver 21 that receives an input of a user; second communicator 27 that communicates with devices 30; and controller 24 that causes input receiver 21 to be in a preparation state in response to second communicator 27 obtaining predetermined information from one device among devices 30. In the preparation state, input receiver 21 is able to receive an execution input for executing scene control of at least part of devices 30. The scene control is related to a life scene.

The one device is, but is not limited to, electric lock 33 in operation example 1 and air conditioner 32 in operation example 2.

Control system 10 configured thus can simplify steps before scene control is executed. Control system 10 eliminates the need for a user input for causing input receiver 21 to be in a preparation state, achieving a quick execution input. In other words, control system 10 can support a quick execution input. Moreover, control system 10 configured thus can omit processing for causing input receiver 21 to be in a cancellation preparation state by a manual input or the like by the user (e.g., the detection of a manual input by display 22). In other words, control system 10 can reduce the amount of information to be processed.

Furthermore, for example, input receiver 21 includes display 22 that includes a function of displaying an image and a function of receiving a manual input of the user, and controller 24 causes input receiver 21 to be in the preparation state by causing display 22 to display an object for executing the scene control.

Control system 10 configured thus displays an object for executing scene control, thereby simplifying steps before the scene control is executed.

Furthermore, for example, display 22 displays the object in a predetermined period from when second communicator 27 obtains the predetermined information from the one device.

Control system 10 configured thus cancels the display of the object after the elapse of the predetermined period, thereby suppressing the continuous display of an unnecessary object.

Furthermore, for example, in response to second communicator 27 obtaining the predetermined information from the one device, controller 24 activates display 22 in a sleep state and causes display 22 activated to display the object.

Control system 10 configured thus activates, even when display 22 is placed in a sleep state, display 22 and displays an object for executing scene control, thereby simplifying steps before the scene control is executed.

Furthermore, for example, the predetermined information indicates a state change of the one device, and controller 24 causes display 22 to display the object for executing the scene control related to a life scene suggested from the state change of the one device, in response to second communicator 27 obtaining the predetermined information from the one device.

Control system 10 configured thus can propose the execution of more proper scene control to the user.

Furthermore, for example, the one device is electric lock 33, the predetermined information indicates that electric lock 33 has been changed from a locked state to an unlocked state, and the life scene suggested from the state change of the one device is a returning-home scene.

In response to a change of electric lock 33 to an unlocked state, control system 10 configured thus can propose, to the user, the execution of scene control related to a returning-home scene.

Furthermore, for example, controller 24 causes display 22 to display the object for executing the scene control in response to second communicator 27 obtaining the predetermined information from the one device in a predetermined time range.

Control system 10 configured thus can display an object for executing scene control, in consideration of whether a time when predetermined information is obtained belongs to a predetermined time range.

Furthermore, for example, controller 24 causes display 22 to display the object for executing the scene control, in response to second communicator 27 obtaining the predetermined information from the one device after execution of another scene control different from the scene control.

Control system 10 configured thus can display an object for executing scene control, in consideration of whether another scene control has been executed before the predetermined information is obtained.

Furthermore, for example, the scene control is related to a returning-home scene, and the other scene control is related to a going-out scene.

Control system 10 configured thus can display an object for executing scene control, in consideration of whether scene control related to a going-out scene has been executed before the predetermined information is obtained.

Furthermore, for example, when display 22 receives a manual input of the user to the object displayed on display 22, controller 24 executes the scene control.

Control system 10 configured thus can execute scene control in response to a manual operation of the user to an object displayed on display 22.

Furthermore, for example, input receiver 21 includes a microphone that receives a voice input of the user as the execution input, and controller 24 causes input receiver 21 to be in the preparation state by activating the microphone.

Control system 10 configured thus activates a microphone that receives a voice input for executing scene control, thereby simplifying steps before the scene control is executed.

A control method executed by a computer such as control system 10 includes: communicating with devices 30; and causing input receiver 21 for receiving an input of a user to be in a preparation state in response to obtaining of predetermined information from one device among devices 30 in the communicating. In the preparation state, input receiver 21 is able to receive an execution input for executing scene control of at least part of devices 30. The scene control is related to a life scene.

Such a control method can simplify steps before scene control is executed.

### (Other Embodiments)

While the embodiment has been described above, the present invention is not limited to the foregoing embodiment.

For example, in the foregoing embodiment, the user can execute scene control with one operation while the execution screen of the scene control is displayed. However, two or more operations may be performed to execute scene control while the execution screen of the scene control is displayed. Scene control is preferably executed by not more than two operations while the execution screen is displayed.

Moreover, the control system implemented by multiple devices in the foregoing embodiment may be implemented as a single device.

For example, the control system may be implemented as a single device corresponding to a control device or may be implemented as a single device corresponding to a portable terminal for conducting the same processing as the control device. When the control system is implemented by multiple devices, constituent elements provided for the control system may be freely allocated to the devices.

For example, a communication method between devices in the foregoing embodiment is not particularly limited. The devices may communicate with one another via a relay, which is not illustrated.

It is possible in the above-described embodiment that the process performed by a certain processing unit may be performed by another processing unit, that an order of a plurality of processes is changed, or that a plurality of processes are performed in parallel.

Any combinations of the above-described operation examples 1 and 2 and variations 1 and 2 are also embodiments of the present invention.

In the above-described embodiment, each of the constituent elements may be implemented by executing a software program suitable for the constituent element. Each of the constituent elements may be implemented when a program executing unit, such a central processing unit (CPU) or a processor, reads a software program from a recording medium, such as a hard disk or a semiconductor memory, and executes the readout software program.

Each of the constituent elements may be implemented by a hardware. For example, the constituent elements may be circuits (or integrated circuit). The circuits may form a single circuit as a whole, or may be different circuits. Each of the circuits may be a general-purpose circuit or a dedicated circuit.

The general and specific aspects according to present invention may be implemented to a system, a device, a method, an integrated circuit, a computer program, or a computer-readable recording medium such as a Compact Disc-Read Only Memory (CD-ROM), or may be any combination of them.

For example, the present invention may be implemented to a control method executed by a computer such as a control system, implemented to a program causing the computer to execute such control method, or implemented to a non-transitory computer-readable recording medium storing the program.

The present invention may include embodiments obtained by making various modifications on the above embodiment which those skilled in the art will arrive at, or embodiments obtained by selectively combining the elements and functions disclosed in the above embodiment, without materially departing from the scope of the present invention.

### REFERENCE SIGNS LIST

10 control system
21 input receiver
22 display
23 microphone
24 controller
27 second communicator (communicator)
30 device
31 illuminator
32 air conditioner
33 electric lock
34 electric shutter
50 server
70 wide area network
80 building

1. A control system comprising:
an input receiver that receives an input of a user;
a communicator that communicates with devices; and
a controller that causes the input receiver to be in a preparation state in response to the communicator obtaining predetermined information from one device among the devices, the preparation state being a state in which the input receiver is able to receive an execution input for executing scene control of at least part of the devices, the scene control being related to a life scene.

2. The control system according to claim 1, wherein
the input receiver includes a display, the display including a function of displaying an image and a function of receiving a manual input of the user, and
the controller causes the input receiver to be in the preparation state by causing the display to display an object for executing the scene control.

3. The control system according to claim 2, wherein
the controller causes the display to display the object in a predetermined period from when the communicator obtains the predetermined information from the one device.

4. The control system according to claim 2, wherein
in response to the communicator obtaining the predetermined information from the one device, the controller activates the display in a sleep state and causes the display activated to display the object.

5. The control system according to claim 2, wherein the predetermined information indicates a state change of the one device, and
the controller causes the display to display the object for executing the scene control related to a life scene suggested from the state change of the one device, in response to the communicator obtaining the predetermined information from the one device.

6. The control system according to claim 5, wherein
the one device is an electric lock,
the predetermined information indicates that the electric lock has been changed from a locked state to an unlocked state, and
the life scene suggested from the state change of the one device is a returning-home scene.

7. The control system according to claim 2, wherein
the controller causes the display to display the object for executing the scene control in response to the communicator obtaining the predetermined information from the one device in a predetermined time range.

8. The control system according to claim 2, wherein
the controller causes the display to display the object for executing the scene control, in response to the communicator obtaining the predetermined information from the one device after execution of another scene control different from the scene control.

9. The control system according to claim 8, wherein
the scene control is related to a returning-home scene, and
the other scene control is related to a going-out scene.

10. The control system according to claim 2, wherein
when the display receives a manual input of the user to the object displayed on the display, the controller executes the scene control.

11. The control system according to claim 1, wherein
the input receiver includes a microphone that receives a voice input of the user as the execution input, and
the controller causes the input receiver to be in the preparation state by activating the microphone.

12. A control method comprising:
communicating with devices; and
causing an input receiver for receiving an input of a user to be in a preparation state in response to obtaining of predetermined information from one device among the devices in the communicating, the preparation state being a state in which the input receiver is able to receive an execution input for executing scene control of at least part of the devices, the scene control being related to a life scene.

13. A non-transitory computer-readable recording medium having recorded thereon a program that causes a computer to execute the control method according to claim 12.
